(19) United States
(12) Patent Application Publication
(10) Pub. No.: US 2015/0192365 A1
(43) Pub. Date: Jul. 9, 2015

(54) METHOD AND DEVICE FOR DETECTING THE SLAG LEVEL IN A METALLURGICAL VESSEL

(71) Applicant: SIEMENS VAI METALS TECHNOLOGIES GMBH, Linz (AT)

(72) Inventor: Christian Koubek, Linz (AT)

(21) Appl. No.: 14/412,833

(22) PCT Filed: Jul. 3, 2013
(86) PCT No.: PCT/EP2013/064015

§ 371 Date: Jan. 5, 2015

(30) Foreign Application Priority Data
Jul. 5, 2012 (DE) 10 2012 211 714.8

(51) Int. Cl. F27D 21/00

(52) U.S. Cl. CPC F27D 21/0028

(57) ABSTRACT

A method and a device for detecting the slag level of a metal melt in a metallurgical vessel (1). At least one signal-generating detecting apparatus (6) is directed at the metallurgical vessel (1) and/or at least at a slag flow (3) out from the metallurgical vessel. In a phase A, a slag level S_{PA} is directly determined from the signals by a processing unit (9). If such direct detection is not possible, the width B_{Mi} of the slag (3) flowing out is detected in at least one direction i and the slag level S_{PB} is determined by the processing unit by the amount of slag S_{M} flowing out. This also controls the amount of carbon carriers introduced into the metallurgical vessel to set the slag level.

### CROSS-REFERENCE TO RELATED APPLICATIONS

The present application is a 35 U.S.C. §§371 National Phase conversion of PCT/EP2013/064015, filed Jul. 3, 2013, which claims priority of German Patent Application No. 102012211714.8, filed Jul. 5, 2012, the contents of which are incorporated by reference herein. The PCT International Application was published in the German language.

### FIELD OF THE INVENTION

The invention relates to a method and to a device for detecting the slag level in a metallurgical vessel and to a method for controlling the slag formation on a metal melt in a metallurgical vessel. In metallurgical processes slags are often used to cover metal melts. This makes it possible to achieve reduced thermal losses, lower consumption of materials and also lower noise levels. Slag must be continuously removed from a metallurgical vessel since new slag is constantly being produced in many metallurgical processes. Knowledge of the amount of slag present or the slag level in the metallurgical vessel is therefore very important and this is significant for controlling the metallurgical process.

### PRIOR ART

Systems and methods are known from the prior art for measuring slag, such as a foamed slag in an arc furnace or the slag in a converter. These are based inter alia on indirect measuring methods in which information about the current level of the slag is obtained from easily accessible measuring signals. The electrode current, electrode voltage (evaluation of harmonics, distortion factor) of an arc furnace, noise emissions, structure-borne noise or even the temperature profile of a heat-conveying element in the wall of the metallurgical vessel inter alia are used in this connection.

A method for enveloping the arc in an arc furnace can be found in DD 228 831 A1. The noise emission caused by the arc is measured and compared to fixed noise limits. In the event of these noise limits being exceeded, a carbon carrier is injected into the furnace or the furnace slag until the noise limit is fallen below again. Since the noise-damping properties change continuously with the composition of the slag, significant uncertainties arise with methods of this kind.

A method for controlling the slag level in an arc can be found in JP62224613A, with the slag level in the furnace being adjusted on the basis of a measured slag level by way of variation of the gas pressure in the furnace.

JP63062812A discloses a method for controlling the slag level in a converter for treating a metal melt, with a temperature distribution in the converter being determined by way of a temperature sensor which is arranged in a blower lance. A covering of the melt with slag is derived from the temperature distribution.

### DESCRIPTION OF THE INVENTION

It is an object of the invention to disclose a method and a device for detecting the slag level in a metallurgical vessel, and a method for controlling the slag formation on a metal melt in a metallurgical vessel which enables easier and more reliable detection.

Detection of a slag level in a metallurgical vessel, for example a converter or an arc furnace, is difficult due to the high temperatures, mechanical loads, significant noise and dust and smoke pollution. These conditions are very unfavorable to sensors and measuring equipment.

The invention enables a slag level to be detected in all operating states. During treatment of a metal melt, it is, for example, necessary to introduce devices such as lances, electrodes or manipulators into the vessel, so it is not always possible to detect the slag level by way of sensors or this is disrupted. Processing states can therefore occur which are caused by production techniques and in which significant amounts of dust or smoke are formed.

The inventive method is based on at least one detecting apparatus which generates signals. The detecting apparatus can be directed at the metallurgical vessel and at least at one slag flow flowing out from the metallurgical vessel. The detecting apparatus can also be directed just at the metallurgical vessel or at least at a slag flow flowing out from this vessel.

In a phase A of a metallurgical process, in which a direct recording of a signal characterizing the slag level S_{PA} in the metallurgical vessel is possible, the slag level S_{PA} is directly determined by a processing unit. In operating phases, in which direct detection of the slag level S_{PA} is not possible, the width B_{Mi} of the slag flowing out can be detected in at least one direction 1 and the slag level S_{PB} can be determined by means of the processing unit on the basis of the amount of slag S_{M} flowing out, wherein the detection device (6) has at least one CCD camera with which visual signals are generated.

From the operation of such methods and detecting apparatus, it has been found that it is possible by way of detection of the slag flow flowing out from a metallurgical vessel to determine the slag level in a metallurgical vessel sufficiently accurately. A proportionality between the slag level and the amount of slag S_{M} flowing out, which flows out in the form of a slag flow, has been found. It has also been found that it is possible to characterize the amount of slag S_{M} flowing out by the cross-section of the slag flow, so indirect detection of the slag level is also possible on the basis of at least one determined width of the slag flow. The cross-section of the slag flow is also proportional to the slag level therefore.

The width B_{M1} of the slag flow flowing out is detected in a direction 1. The amount of slag S_{M} flowing out is proportional to the width B_{M1}. The slag level S_{PB} can be determined by way of a correction factor F_{KA}. The correction factor F_{KA} is continuously determined during phase A from the quotient of slag level S_{PA} and width B_{M1}.

S_{PA}∞B_{M1}×F_{KA}

The state of the channel via which the slag flow flows out, and therewith the cross-section of the slag flow, is always taken into account in phase A as a result, so the measurement of a width of the slag flow is sufficient.

This is possible since a characteristic form of the slag flow is always established from which a conclusion can be drawn about the slag level.

Alternatively, in the case of the inventive method, the width of the slag flow flowing out is detected in two substantially perpendicular directions 1 and 2, wherein the widths B_{M1} and B_{M2} are determined and the amount of slag S_{M} flowing out is proportional to the product of the widths B_{M1} and B_{M2}. The slag level S_{PB} can be determined by way of a correction factor F_{KB}. The correction factor F_{KB} can be continuously determined empirically or during phase A from the slag level S_{PA} and the product of B_{M1} and B_{M2}.

S_{PA}∞B_{M1}×B_{M2}×F_{KB}

A conclusion can easily be drawn about the slag level S_{PB} by way of the proportionality between the slag level and the amount of slag flowing out on the basis of the correction factor F_{KB}.

The correction factor takes into account differences in the actual cross-section of the slag flow from the theoretical rectangular shape. An empirical determination of the correction factor is easily possible because the set cross-section is usually constant. In this case, an additional direction detection of the slag in the metallurgical vessel may be omitted.

Alternatively, the correction factor can also be determined from the measurement of the slag level S_{PA} in phase A and the measured product of B_{M1} and B_{M2}. The correction factor does not have to be determined constantly, however, since the cross-sectional shape of the slag flow does not change rapidly over time.

A specific embodiment of the inventive method provides that the slag level S_{PA} is detected in phase A in the metallurgical vessel, in particular through an open slag door in the metallurgical vessel. The detecting apparatus detects the slag directly in the metallurgical vessel in this case, with an opening in the metallurgical vessel being used. The detecting apparatus can be protected from the extreme conditions in and directly around the metallurgical vessel due to the distance between the detecting apparatus and the metallurgical vessel. When used through an open slag door the method can only be used in phases with an open slag door.

A further embodiment of the inventive method provides that the slag level S_{PA} is detected in phase A by way of an edge detection on the slag in the metallurgical vessel. Detection is therefore carried out on the top edge of the slag and the slag detected directly in the metallurgical vessel.

According to a preferred embodiment of the inventive method, the detecting apparatus has a detecting region which detects the slag in the metallurgical vessel and the slag flow flowing out from the metallurgical vessel. This embodiment enables detection of the slag in the metallurgical vessel and the slag flow flowing out using just one detecting apparatus. Detection is therefore still possible indirectly by way of the cross-section of the slag flow flowing out, and therewith the amount of slag flowing out, even in cases in which direct detection of the slag level in the metallurgical vessel is not possible. Detection is therefore possible even in those operating states of a metallurgical process in the metallurgical vessel which are very unfavorable per se to detection.

According to an alternative embodiment of the inventive method, the detecting apparatus has a detecting region which detects only the slag flow flowing out from the metallurgical vessel. The at least one detecting apparatus can be arranged for example under the metallurgical vessel or under the slag outlet of the vessel or even directed at such a position, so the detecting apparatus is better protected, for example against adverse operating conditions. Manipulations in the metallurgical vessel or smoke or dust are not a problem in this arrangement or orientation.

According to a specific embodiment of the inventive method, the detecting apparatus has at least one CCD camera, in particular working in the near infrared range, with which visual signals, in particular images, are generated. By limiting the wavelength range, it is possible to restrict detection to radiation characteristic of the slag, so undesirable environmental factors or other radiation sources may be ruled out. This achieves additional reliability in detection. CCD cameras have, moreover, the advantage that they are inexpensive to obtain and due to appropriate protection measures can also be used under difficult environmental conditions (heat, dust, smoke, vibrations). Appropriate lens systems also allow an adjustment to the respective individual situation, so the detecting region or the installation situation can be adjusted.

According to the invention, the visual signals are images, with the slag level S_{PA} and the widths B_{M1} and/or B_{M2} each being determined from separate fields in the images. Regions of the images are used for this purpose, so the processing unit can tap or read and convert two or more fields from one image. For example, the slag level can be determined from an image by means of one field and the width of the slag flow can also be determined by means of another field in the same image, so for example, the correction factor F_{KA} can be determined by means of the processing unit. The processing unit can, however, also tap fields from different detecting apparatus and process them together.

A preferred embodiment of the inventive method provides that the determined slag level S_{PA} and/or the slag level S_{PB} is used to control the amount of carbon which is added to the metallurgical vessel for forming slag, in particular foamed slag. It is known to introduce carbon carriers into a metallurgical vessel in which a metal melt and slag are located. Slag formation is stimulated thereby and the volume of slag is increased by a formation of gas. Due to the constant detection of the slag level, the supply of carbon carrier can be easily controlled and the slag level can thus be kept at a desired state. The detected slag level can, however, basically also be used for process adjustments or for configuration of the metallurgical process.

The inventive device for detecting the slag level on a metal melt in a metallurgical vessel, in particular an arc furnace, includes at least one signal-generating detecting apparatus which is directed at the metallurgical vessel and/or at least one slag flow flowing out from this vessel via a channel. A slag level S_{PA} is determined in a phase A by means of a provided processing unit, and/or if a direct visual detection of the slag level S_{PA} is not possible, the width B_{Mi} of the slag flow flowing out is detected in at least one direction 1, and the slag level S_{PB} is determined by means of the processing unit on the basis of the amount of slag S_{M} flowing out. A conclusion can be drawn about the slag level in the metallurgical vessel from the slag flow cross-section by way of the proportionality between the amount of slag S_{M} flowing out and the slag level S_{PB} and the proportionality between the amount of slag S_{M} flowing out and the cross-section of the slag flow. Furthermore, the detecting apparatus can either detect the slag level or the cross-section of the slag flow or both variables, so the processing unit can determine these together from the same signal. A very simple device is advantageously created thereby.

According to the embodiment of the inventive device, two perpendicular, in particular underfloor, detecting apparatus are provided for detecting the widths of the slag flow flowing out, wherein the widths B_{M1} and B_{M2} are determined and the amount of slag S_{M} flowing out is determined proportional to the product of the widths B_{M1} and B_{M2} and a correction factor F_{KB}, wherein the correction factor F_{KB} is continuously determined empirically or during phase A from the slag level S_{PA} and the product of B_{M1} and B_{M2}. The underfloor arrangement under the iron and steel works floor has the advantage that the detecting apparatus can be arranged so as to be protected and does not lead to a restriction in the region of the metallurgical vessel, moreover, since unrestricted control and manipulation of for example blower lances or electrodes must be possible here. The detecting apparatus can detect the slag flow without disruptions, moreover. The slag flow can be detected so well by way of the widths B_{M1} and B_{M2} that the cross-section of the slag flow, and therewith the amount of slag flowing out, can be determined by way of a correction factor. The correction factor can be determined empirically, with this usually only having to occur once. The correction factor can also be determined from the slag level S_{PA} and the product of B_{M1} and B_{M2}.

A preferred embodiment of the inventive device provides that the signals are visual signals, in particular images, and are determined by the processing unit in each case from separate fields in the images of the slag level SPA and widths B_{M1} and B_{M2}. Visual signals, and in particular images, are common technically, so the processing of such signals by the processing unit is also well controlled. Separate fields are tapped from the images by the processing unit, so various items of information are obtained in the form of fields from one image. Information relating to the slag flow, in the form of widths, can also be tapped therefore in addition to the slag level, for example using the same image. There are also standardized formats for images which can be effectively evaluated.

According to a specific embodiment of the inventive device, the detecting apparatus has at least one CCD camera, working in particular in the near infrared range and having in particular a daylight filter. Cameras of this kind can be appropriately adjusted by way of the lens system, so the desired regions of the slag can be detected. Environmental factors can be largely masked for detection and the slag optimally detected by way of filters and a defined wavelength range.

According to the invention, the detecting apparatus has a detecting region which detects the slag in the metallurgical vessel, in particular through an opening, preferably through an open slag door, and detects the slag flow flowing out from the metallurgical vessel. It is thereby possible to simultaneously detect the slag in a metallurgical vessel and the slag flow with one detecting apparatus. Openings can be used during detection in the metallurgical vessel, so the detecting apparatus can be arranged away from the extreme conditions (sound pressure, heat, dust, smoke) and is stressed less as a result.

According to an alternative embodiment of the inventive device, the detecting apparatus has a detecting region which detects only the slag flow flowing out from the metallurgical vessel. The detecting apparatus can therefore be arranged even further away from the metallurgical vessel or in a shielded region. It is possible for example to arrange the detecting apparatus under the metallurgical vessel, so the stress on the detecting apparatus can be reduced further.

The inventive method for controlling the slag formation on a metal melt in a metallurgical vessel, in particular in arc furnace, is characterized in that the amount of carbon which is added to the metallurgical vessel for forming slag, in particular foamed slag, is controlled on the basis of the slag level S_{PA} and/or the slag level S_{PB}, determined according to the method disclosed herein. The slag is used to shield the metal melt in a metallurgical process. This results in advantages in relation to thermal losses and also pollution of the environment due to noise emissions and waste gases. Efficient and prompt control is ensured by the continual determination of the slag level. Injecting lances, which are provided for injecting carbon carriers into an arc furnace, are controlled on the basis of the determined slag level and a desired slag level can be maintained at all times.

### BRIEF DESCRIPTION OF THE DRAWINGS

The invention will be described by way of example with reference to a schematic figure, in which:

FIG. 1 shows an arc furnace with the inventive detecting apparatus for the slag in the furnace and the slag flow flowing out,

FIG. 2 shows an arc furnace with the inventive detecting apparatus for the slag flow flowing out,

FIG. 3 shows the arrangement according to FIG. 2 in a plan view

FIG. 4 shows a detail of FIG. 2 likewise in a plan view

### DESCRIPTION OF EMBODIMENTS

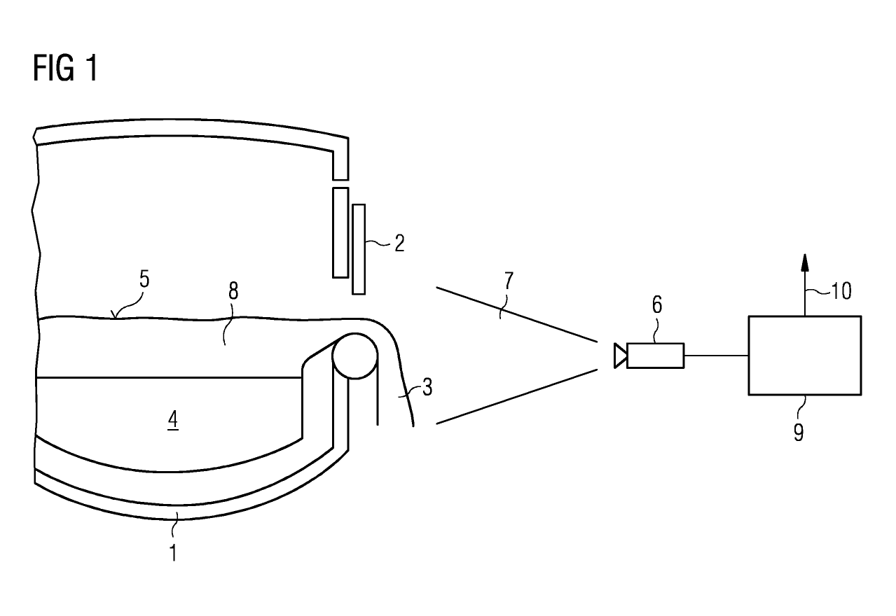

FIG. 1 shows a metallurgical vessel 1, such as an arc furnace, for treating a metal melt, having an open slag door 2. Slag flows out through the opening and forms a slag flow 3. There is a metal melt 4 in the metallurgical vessel 1 and a slag thereabove it having a slag level 5.

The slag 8 in the arc furnace and the slag flow flowing out are detected by means of a detecting apparatus 6, which has a detecting region 7. A CCD camera for example can be used as the detecting apparatus 6. This usually works in the near infrared range and has a daylight filter. The CCD camera detects the slag level 5 in the metallurgical vessel 1, with, for example, an edge detection being applied. The slag flow is also detected by the CCD camera.

The signals or images generated by the detecting apparatus 6 are fed to a processing unit 9. The signals or images from the CCD camera are processed here. A slag level is determined from the signals in the process or an area of the slag flow is calculated from the detected width B_{M1} of the slag flow flowing out on the basis of the correction factor F_{KA}. The amount of slag flowing out can be determined from this area and the slag level in the arc furnace can in turn be determined therefrom. Proportionalities and/or empirically determined correlations are used in the process. The determined control variables 10 can be supplied to a controller (not shown) which controls the entry of slag-forming substances or substances that increase slag volume, such as carbon carriers, on the basis of the current slag level, so a desired slag level can always be maintained. The arc furnace can be operated more efficiently as a result, for example the use of electrodes and refractories can be reduced.

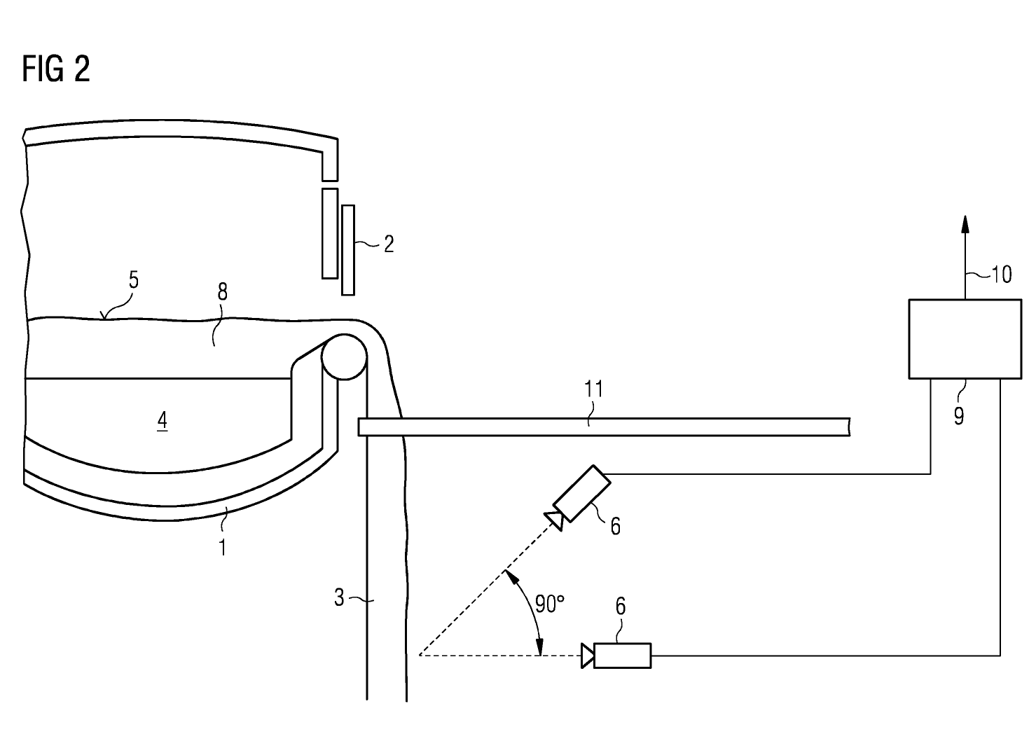

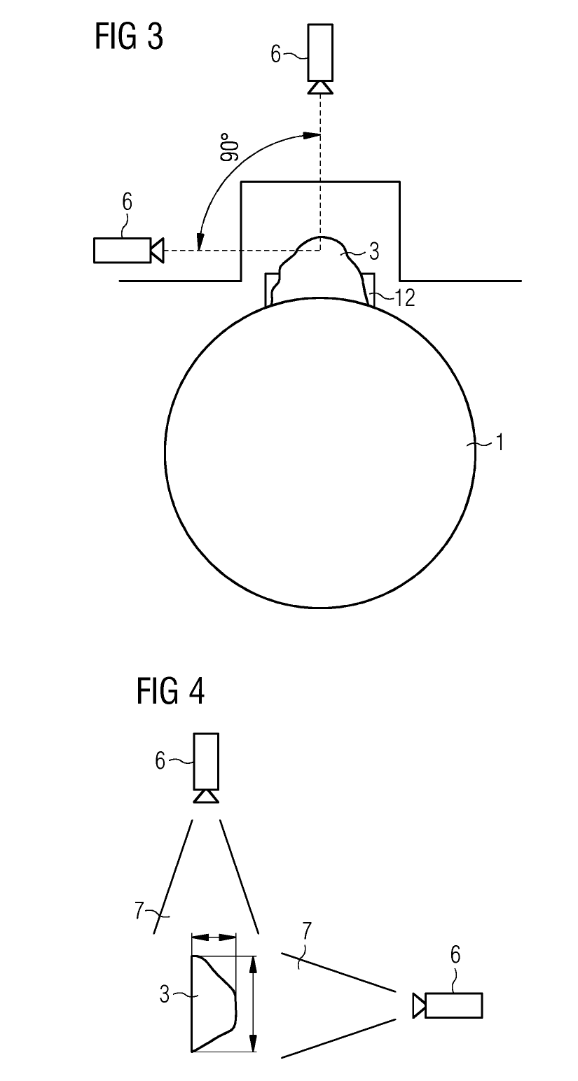

FIG. 2 also shows a metallurgical vessel 1 having an open slag door 2. Two detecting apparatus 6 are provided for detecting the slag flow 3 flowing out. FIG. 3 shows this arrangement in a plan view. The two detecting apparatus 6 are arranged mutually offset at an angle of 90° and directed at the slag flow 3. The slag flow 3 flows out from the metallurgical vessel 1 via a channel 12.

It can be seen in FIG. 2 that the detecting apparatus 6 are arranged under the iron and steel works floor 11, so a very protected position is achieved. The detecting apparatus 6 are arranged on the same plane in the vertical direction. In FIG. 2 the detecting apparatus 6 are shown axonometrically tilted. This is merely for the purpose of improved visibility. Further spatial positions of the detecting apparatus 6 are also possible, however.

A processing unit 9 is provided for processing the signals of the detecting apparatus 6. The widths B_{M1} and B_{M2} of the slag flow 3 can be determined in two mutually perpendicular directions by means of the detecting apparatus 6.

This is shown in more detail in FIG. 4. The two detecting apparatus 6 have detecting regions 7 and detect the widths of the slag flow 3. A typical cross-section of the slag flow 3 is shown, with the width on the side of the metallurgical vessel usually being wider than at the applied side.

The amount of slag S_{M} flowing out is proportional to the slag level and therefore also to the product of the widths B_{M1} and B_{M2} and a correction factor F_{KB}. The correction factor F_{KB} can be determined empirically. F_{KB} takes account of the difference in the actual slag flow cross-section from the ideal rectangular shape and changes in the cross-section of the outflow from the metallurgical vessel, such as the width of the slag opening. Alternatively, the two detecting apparatus 6 can be coupled to an additional detecting apparatus (not shown). The detected slag level thereof, wherein detection occurs in phases in which direct detection of the slag level in the metallurgical vessel is possible, can also be used for adjustment of the correction factor.

A correlation between the slag level and the amount of slag flowing out or the measured slag cross-section can also be determined.

However, it is also conceivable that one of the two detecting apparatus 6 arranged at a right angle to each other has a detecting region which also detects the slag 8, and therewith the slag level 5 in the metallurgical vessel, in addition to the slag flow 3. A conclusion can easily be drawn about the slag level 5 from the slag cross-section by way of the proportionality between the slag level 5 and the amount of slag flowing out or the slag cross-section. The determined control variables 10 can in turn be supplied to a controller (not shown) for the slag level.

### LIST OF REFERENCE NUMERALS

1 metallurgical vessel
2 slag door
3 slag flow
4 metal melt
5 slag level
6 detecting apparatus
7 detecting region
8 slag in the metallurgical vessel
9 processing unit
10 control variables
11 iron and steel works floor
12 channel

1-14. (canceled)

15. A method for detecting a slag level on a metal melt in a metallurgical vessel, comprising:
directing at least one signal-generating detecting apparatus at slag flow flowing out from the vessel, directly determining a slag level in the vessel by operating a detecting apparatus to detect a slag flow and to generate a signal from which a slag level in the vessel may be determined from the generated signal; and
determining the slag level by processing the generated signal.

16. The method of claim 15, wherein the slag level in the vessel is determined by detecting the width of the slag flow in at least one direction across the flow of slag as the slag flow flows out of the vessel, and generating a signal based on the width of the slag flow; and
then determining the slag level in the vessel by processing the generated signal which is based on the width of the slag flow out of the vessel.

17. The method of claim 16, further comprising the detecting of the width of the slag flow is performed by at least one ccd camera which generates visual signals that are detected by the detecting apparatus which generates a signal used by the processing unit to determine slag flow.

18. The method of claim 16, further comprising determining the slag flow in one direction as a product of the width of the slag flow exiting the vessel and a set correction factor, and determining the correction factor continuously from a quotient of the slag level.

19. The method of claim 18, further comprising:
detecting the width of the slag flowing out of the vessel by detecting the flow in two substantially perpendicular directions, in a plane through the slag flow, and making a separate width determination of the slag flow in each of the substantially perpendicular directions and generating the signal;
determining the amount of slag detected to be flowing out of the vessel proportional to the product of the width in the first direction and the width in the second direction based on the generated signal and a correction factor based on the signal; and
continuously determining the correction factor empirically or during a phase from the slag level and the product of the first and second widths of the slag flow in the perpendicular directions.

20. The method of claim 15, wherein the vessel has a slag door, which is open to permit exit of slag from the vessel, and the method further comprises detecting the slag level in the vessel through the open slag door in the vessel.

21. The method of claim 15, further comprising detecting the slag level by an edge detection on the slag in the vessel.

22. The method of claim 15, wherein the detecting apparatus detects the slag in the vessel and detects the slag flow out from the vessel and determines the slag in the vessel by both of the detections.

23. The method of claim 16, further comprising detecting the slag in the vessel based only on the flow of slag out from the vessel.

24. The method of claim 17, wherein the detecting apparatus includes at least one ccd camera working in the near infrared range with which images are generated.

25. The method of claim 17, wherein the visual signals are images and the slag level in the vessel or the width measurements of the slag level exiting the vessel are each determined from separate fields in the images.

26. The method of claim 15, further comprising using the slag level detected in the vessel or measured in the vessel to generate the signal to cause the processing of the generated signal to control addition of carbon into the metallurgical vessel that forms slag.

27. The method as claimed in claim 15, further comprising the steps of adding carbon to the metallurgical vessel during formation of slag for forming slag and controlling an amount of carbon being added based on the slag level determined.

28. An apparatus for detecting a slag level in a metallurgical vessel, the apparatus comprising:
at least one detecting and signal generating apparatus directed at the vessel and configured and operable for detecting an amount of slag flowing out from the vessel and/or detecting the slag level in the vessel and generating a signal; and
a processing unit for determining the slag level in the vessel based on the amount of slag flowing out or slag level detected and based on the resultant signal generated.

29. The apparatus of claim 28, further comprising the vessel having an opening to permit outlet of slag from the vessel in a manner such that a width of the slag flow flowing out of the vessel can be detected;
the slag flow detecting apparatus configured and located for detecting out flow of slag from the vessel in at least one direction and for generating a signal as to the out flow of slag; and
the processing unit being configured for determining the slag flowing out from the vessel in the at least one direction based on the generated signal.

30. The apparatus of claim 29, wherein the vessel is configured to provide a slag flow of a measurable width as the slag flows, wherein the amount of slag flowing out from the vessel can be determined based upon the width of the slag flow detected.

31. The apparatus of claim 30, further comprising:
two of the detecting apparatus configured, positioned and operable for taking two measurements of slag flow in two substantially perpendicular directions with respect to a plane of the detectors and the slag flows;
the detecting apparatus configured to generate respective signals corresponding to each slag flow measured; and
the processing unit being configured for using the signal as to each of the measurements of width from each of the detectors to determine the amount of slag flowing out from the vessel and for determining that amount by determining a product of the widths of the two slag flows and a correction factor, and the processing unit being further configured for continuously empirically determining the correction factor during the measurements of the slag flow.

32. The apparatus of claim 31, wherein the signals detected by the detecting apparatus are visual signals, and the detecting apparatus is configured for detecting the slag flow based on the visual signals including images of a slag level and images of a width of an exit flow of slag from the vessel.

33. The apparatus of claim 32, wherein the detecting apparatus includes at least one ccd camera operating in a near infrared range.

34. The apparatus of claim 33, wherein the ccd camera has a daylight filter.

35. The apparatus of claim 28, wherein the vessel includes an opening through which the slag exits the vessel and through which the detecting apparatus also may detect the slag flow out from the vessel.

36. The apparatus of claim 28, wherein the detecting apparatus is configured and operable to detect only the slag flowing out from the metallurgical vessel and not the level of the slag in the vessel.
